(19) United States
(12) Patent Application Publication
(10) Pub. No.: US 2026/0342207 A1
(43) Pub. Date: Oct. 29, 2026

(54) SOFT-SWITCHNG INVERTER DESIGN FOR ELECTRICAL MOTORS WITH SIGNIFICANT PARASITIC CAPACITANCES

(71) Applicant: Deere & Company, Moline, IL (US)

(72) Inventors: Nan LIN, Fargo, ND (US); Brij N. SINGH, Fargo, ND (US); Yuheng WU, Fargo, ND (US); Zachary WEHRI, Fargo, ND (US); Long WU, Fargo, ND (US)

(73) Assignee: Deere & Company, Moline, IL (US)

(21) Appl. No.: 19/542,313

(22) Filed: Feb. 17, 2026

Related U.S. Application Data
(60) Provisional application No. 63/796,339, filed on Apr. 28, 2025.

(51) Int. Cl. H02M 1/08; H02M 1/00; H02M 1/088; H02M 1/15; H02M 7/48; H02M 7/523; H02P 27/08

(52) U.S. Cl. CPC H02M 1/083; H02M 1/0009; H02M 1/0058; H02M 1/088; H02M 1/15; H02M 7/4811; H02M 7/523; H02P 27/085

(57) ABSTRACT

An electric drive includes an inverter and processing circuitry configured to cause the electric drive to adjust at least one of a resonant capacitance or a resonant inductance of the inverter to cause the inverter to operate in a soft switching mode, in response to the inverter being in a hard switching mode.

### CROSS-REFERENCE TO RELATED APPLICATIONS

This application claims priority under 35 U.S.C. § 119(e) to U.S. Provisional Appln. No. 63/796,339 filed on Apr. 28, 2025, the entire contents of which are hereby incorporated by reference.

### GOVERNMENT LICENSE RIGHTS

This invention was made with government support under DE-EE0009874 awarded by United States Department of Energy. The government has certain rights in the invention.

### SUMMARY

Some example embodiments provide systems and methods for multi-objective design for an auxiliary resonant commutated pole inverter.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For the purposes of clarity, various dimensions of the drawings may have been exaggerated.

FIG. 1 illustrates a schematic of an electric drive system according to an example embodiment.

FIG. 2 illustrates an equivalent circuit of the inverter shown in FIG. 1.

FIG. 3A illustrates one phase-leg of the inverter shown in FIG. 2.

FIG. 3B is an operation waveform for one switching cycle of the one phase-leg shown in FIG. 3A.

FIG. 3C illustrates a diagram of variable timing control according to example embodiments.

FIGS. 4A and 4B illustrate soft switching failure scenarios.

FIG. 5 shows a graph illustrating a commutation process shown in FIGS. 4A and 4B.

FIG. 6 illustrates a hybrid resonance circuit according to some example embodiments.

FIG. 7A illustrates an implementation of a variable resonant inductor according to example embodiments.

FIG. 7B illustrates an implementation of a variable resonant capacitor according to example embodiments.

FIG. 8 illustrates a sensing circuit and a resonance impedance control circuit according to example embodiments.

FIG. 9 is a flow chart illustrating a method of controlling an inverter according to example embodiments.

FIG. 10 is a flow chart illustrating a method of controlling an inverter according to example embodiments.

FIG. 11 is a flow chart illustrating a method of controlling an inverter according to example embodiments.

FIG. 12 is a flow chart illustrating a method of controlling an inverter according to example embodiments.

FIG. 13A illustrates a soft switching failure caused by a high-frequency current ripple from parasitic capacitance of an electronic machine.

FIG. 13B illustrates a resonant current covering the high-frequency current ripple according to example embodiments.

FIG. 14 illustrates a comparator circuit and a soft switching compensation unit according to example embodiments.

FIG. 15 is a flow chart illustrating a method of controlling the inverter 105a according to example embodiments.

FIGS. 16A and 16B are graphs illustrating a voltage fall time in a soft switching mode according to example embodiments.

FIG. 16C illustrates the voltage fall time in a hard switching mode according to example embodiments.

FIG. 16D illustrates the voltage fall time in a partial soft switching mode according to example embodiments.

FIG. 17A is a graph illustrating a gate-source voltage of complimentary main switches when the inverter is in a soft switching mode according to example embodiments.

FIG. 17B is a graph illustrating a gate-source voltage of complimentary main switches when the inverter is in a hard switching mode according to example embodiments.

FIG. 18A illustrates a voltage monitor circuit and a soft switching compensation circuit according to example embodiments.

FIG. 18B illustrates an RC circuit according to example embodiments.

FIG. 19 is a flow chart illustrating a method of controlling the inverter 105a according to example embodiments.

FIG. 20A is a graph showing voltages measured at a gate of the main switch and output from an RC circuit in the soft switching mode.

FIG. 20B is a graph showing voltages measured at the gate of the main switch and output from the RC circuit in the hard switching mode.

### DETAILED DESCRIPTION

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

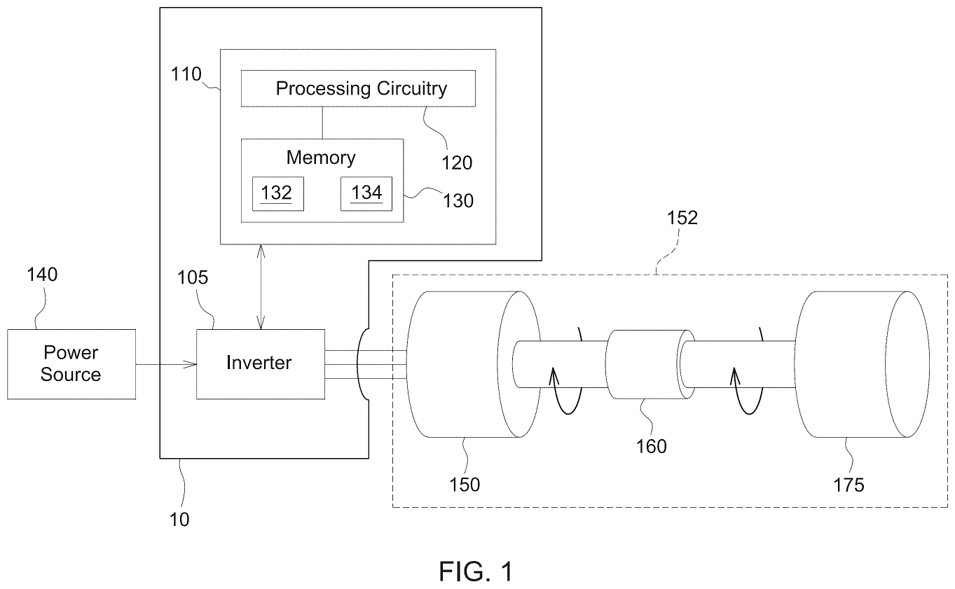

FIG. 1 illustrates a schematic of an electric drive system according to an example embodiment.

As shown in FIG. 1, an electric drive 10 includes an inverter 105 and a controller 110 to generate commands (e.g., voltage and/or current commands) for an electric machine 150 (e.g., an electric motor). The electric machine 150 is part of a modeled electro-mechanical system 152. In addition to the electric machine 150, the modeled electro-mechanical system 152 includes a mechanical load 175 and a coupler 160. The electric machine 150 is coupled to the mechanical load 175 though the coupler 160 (e.g., a compliant coupler modelled by stiffness and damping properties). The coupler 160 comprises a mechanical, rotational coupler, such as a flexible coupler, a bellows coupler, a flexible joint, a universal joint, a flange coupler, a gearbox, or a transmission, for example. The electric machine 150 is configured to drive the mechanical load 175 based on the commands provided to the electric machine 150 from the controller 110. A power source 140 provides power to the inverter 105. For example, the power source 140 may provide DC power to the inverter 105. For example, the power source 140 may be a battery. The inverter 105 may convert DC input into AC current to drive the electric machine 150.

In some example embodiments, the controller 110 includes processing circuitry 120 and memory 130. The controller 110 is configured to perform the methods and algorithms described herein. In some example embodiments, the processing circuitry 120 is configured to execute instructions stored in the memory 130 to cause the electric drive 10 to perform the methods and algorithms described herein. In some example embodiments, the controller 110 may be electrically connected to the inverter as shown in FIG. 1. However, example embodiments are not limited thereto and in some example embodiments the controller 110 may implement a simulation of the inverter 105.

The term ‘processing circuitry,’ as used in the present disclosure, may refer to, for example, hardware including logic circuits; a hardware/software combination such as a processor executing software; or a combination thereof. For example, the hardware more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

According to some example embodiments, the memory 130 may be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art.

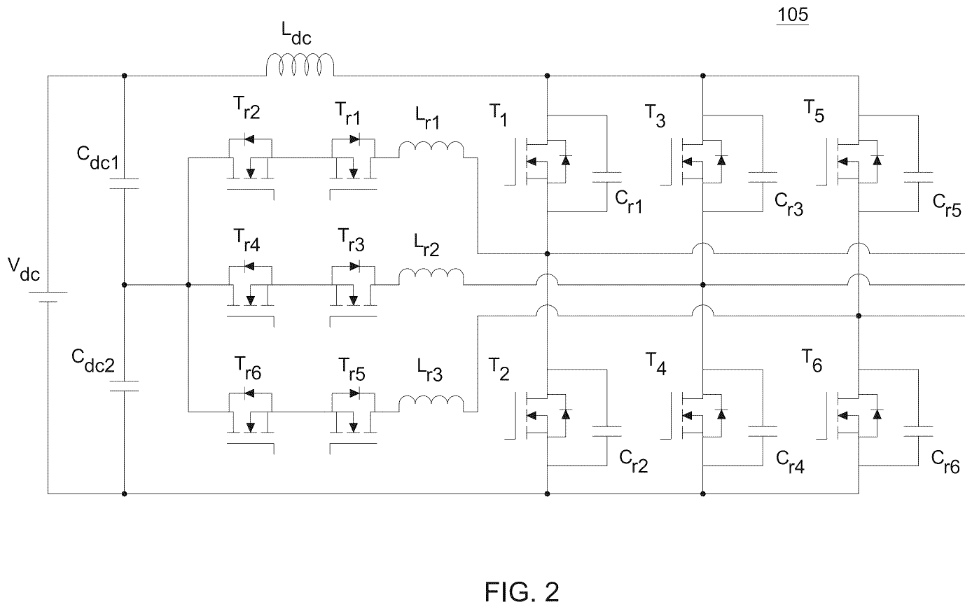

FIG. 2 illustrates an equivalent circuit of the inverter shown in FIG. 1.

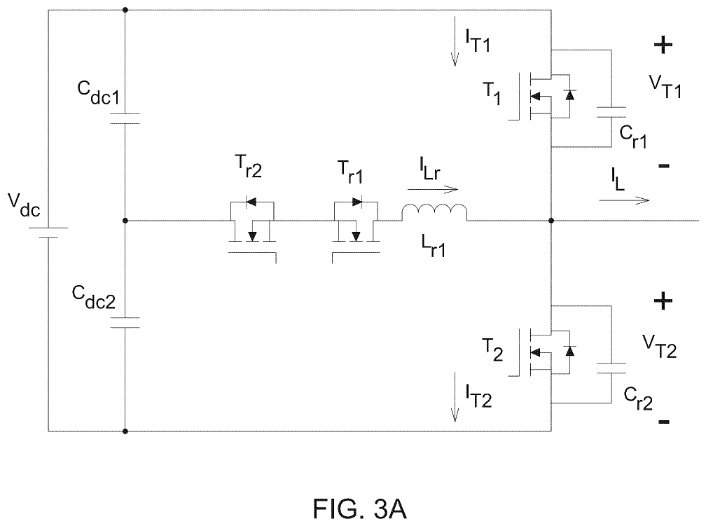

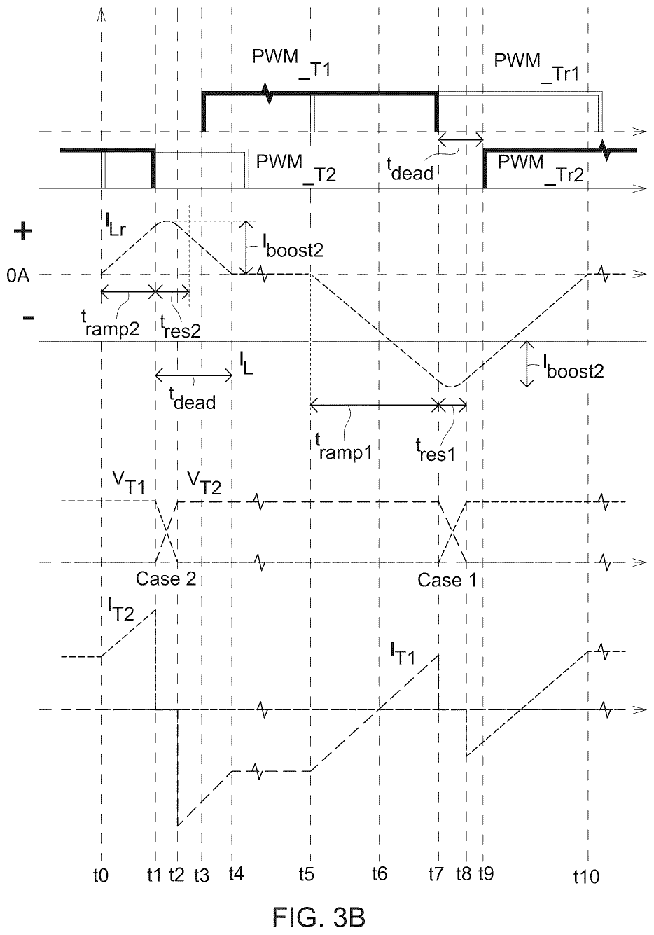

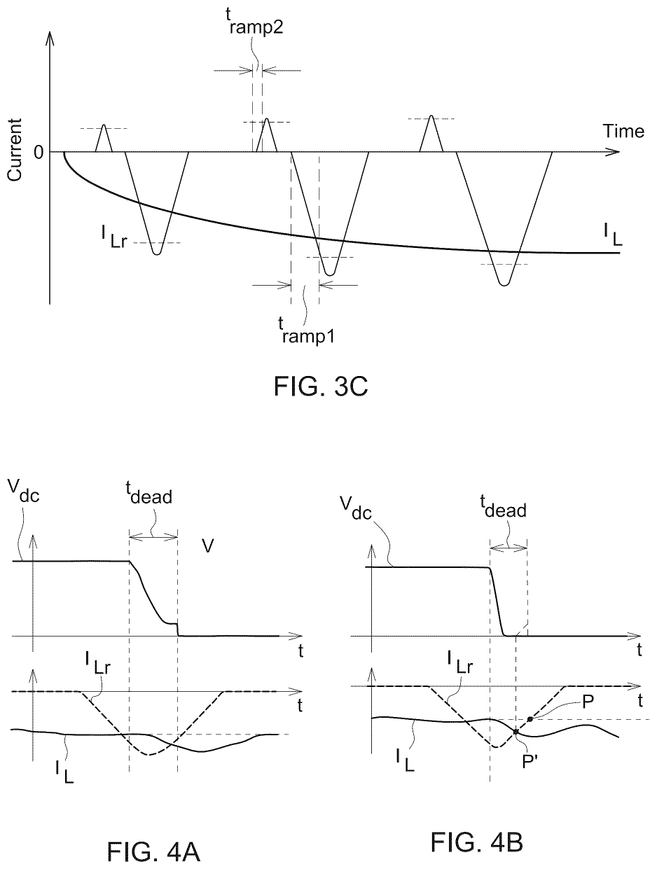

Referring to FIG. 2, inverter 105 may include first capacitors C_{dc1}-C_{dc2}, second capacitors Cᵣ₁-Cᵣ₆, first switches T₁-T₆, second switches Tᵣ₁-T_{R6}, inductors Lᵣ₁-Lᵣ₃ and/or inductor L_{dc}. The inverter 105 may receive an input voltage V_{dc} from, for example, the power source 140 and may output an output voltage V_{ac} to, for example, the electric machine 150. The first switches T₁-T₆ may be referred to herein as main switches and the second switches Tᵣ₁-T_{R6} may be referred to herein as auxiliary switches. The first switches T₁-T₆ and the second switches Tᵣ₁-Tᵣ₆ may be switching semiconductors (e.g., insulated gate bipolar transistors (IGBT), silicon carbide (SiC) metal-oxide-semiconductor field effect transistors (MOSFETs), or other power transistors). The first switches T₁-T₆ may be turned on under zero voltage switching (ZVS). Auxiliary switches Tᵣ₁-Tᵣ₆ may realize zero current switching (ZCS) during turn-off periods. The first capacitors C_{dc1}-C_{dc2} may be referred to herein as main capacitors and the second capacitors Cᵣ₁-Cᵣ₆ may be referred to herein as resonant capacitors. The inductors Lᵣ₁-Lᵣ₃ may be referred to as resonant inductors and may be variable inductors. The auxiliary switches Tᵣ₁-Tᵣ₆ along with the second capacitors Cᵣ₁-Cᵣ₆ may be referred to as an auxiliary circuit. For example, auxiliary switches T₁ and Tᵣ₂ and second capacitors Cᵣ₁ and Cᵣ₂ may form an auxiliary circuit of one phase leg of the inverter 105 (discussed in more detail below with regard to FIG. 3A).

According to some example embodiments, the inverter 105 may be an auxiliary resonant commutated pole (ARCP) inverter.

As shown in FIG. 2, a first terminal of the first capacitor C_{dc1} is connected to a first terminal of inductor L_{dc}. A second terminal of inductor L_{dc} is connected to a drain of first switches T₁, T₃, and T₅. A first terminal of the first capacitor C_{dc2} is connected to a source of first switches T₂, T₄, and T₆. A second terminal of capacitor C_{dc1} is connected to a second terminal of first capacitor C_{dc2} and to drains of second switches Tᵣ₂, Tᵣ₄, and Tᵣ₆. Sources of second switches Tᵣ₂, Tᵣ₄, and Tᵣ₆ are connected, respectively, to sources of second switches Tᵣ₁, Tᵣ₃, and Tᵣ₅. Drains of second switches Tᵣ₁, Tᵣ₃, and Tᵣ₅ are connected, respectively, to first terminals of inductors Lᵣ₁, Lᵣ₂, and Lᵣ₃. A second terminal of inductor L₁ is connected to a source of first switch T₁ and a drain of second switch T₂. A second terminal of inductor Lᵣ₂ is connected to a source of first switch T₃ and a drain of first switch T₄. A second terminal of inductor Lᵣ₃ is connected to a source of first switch T₅ and a drain of first switch T₆. Each of first switches T₁-T₆ is connected in parallel to a respective second capacitor Cᵣ₁-Cᵣ₆. For example, a first terminal of each second capacitor Cᵣ₁-Cᵣ₆ is connected to a source of a respective first switch T₁-T₆ and a second terminal of each second capacitor Cᵣ₁-Cᵣ₆ is connected to a drain of the respective first switch T₁-T₆. Thus, a resonant capacitor Cᵣ is connected in parallel to each main switch T while a resonant inductor Lᵣ is connected between the auxiliary switches Tr and a middle point in each phase of the inverter 105.

The controller 110 may control the first switches T₁-T₆ and the second switches Tᵣ₁-Tᵣ₆ to provide soft switching in which voltage and current waveforms of the switches do not overlap with each other, so that the switching energy is reduced, as described in R. W. De Doncker and J. P. Lyons, “The auxiliary resonant commutated pole converter,” Conference Record of the 1990 IEEE Industry Applications Society Annual Meeting, Seattle, WA, USA, 1990, pp. 1228-1235 vol. 2 and Bijlenga et al. “ARCP CONVERTER AND A METHOD FOR CONTROL THEREOF,” U.S. Patent US 2004/0246756A1, Dec. 9, 2004, which are herein incorporated by reference in its entirety.

FIG. 3A illustrates one phase leg of the inverter 105.

FIG. 3B is an operation waveform for one switching cycle of the one phase-leg of the inverter 105 shown in FIG. 3A.

FIG. 3C illustrates a diagram of variable timing control according to example embodiments.

Referring to FIGS. 3A to 3C, the top two rows of FIG. 3B show pulse-width modulation (PWM) signals PWM_{T1}, PWM_{T2}, PWM_{Tr1}, and PWMTᵣ₂ of main switches T₁ and T₂ and auxiliary switches Tᵣ₁ and Tᵣ₂, respectively. The middle rows of FIG. 3B show a load current I_{L} and an inductor current I_{Lr} through the resonant inductor Lᵣ₁. The bottom two rows of FIG. 3B show voltage waveforms V_{T1} and V_{T2} and current waveforms I_{T1} and Iₜ₂ of the main switches T₁ and T₂, respectively.

As shown in FIG. 3B, a switching cycle may include two resonant inductor current pulses with different amplitudes. A resonance period occurs during the periods when the absolute value of the inductor current I_{Lr} is higher than the dashed lines shown in FIG. 3C.

The time during which the resonant inductor Lᵣ₁ current ramps up before the resonance period is denoted in FIGS. 3B and 3C as first and second ramp periods tᵣₐₘₚ₁ and tᵣₐₘₚ₂. The ramp period tᵣₐₘₚ for the inductor current I_{Lr} pulse with higher amplitude in a switching cycle is denoted as a first ramp period tᵣₐₘₚ₁ while the ramp period tᵣₐₘₚ for the inductor current I_{Lr} pulse with a lower amplitude in a switching cycle is denoted as a second ramp period tᵣₐₘₚ₂.

First ramp period tᵣₐₘₚ₁ and second ramp period tᵣₐₘₚ₂ are also the periods during which a main switch T₁ or T₂, and its corresponding auxiliary switch Tᵣ₁ or Tᵣ₂ are turned on at the same time, as shown in FIG. 3B. The first and second ramp periods tᵣₐₘₚ₁ and tᵣₐₘₚ₂ determine the amplitude of inductor current I_{Lr} pulses, which further affect the following resonances of the circuit. Variable timing control may be achieved, according to example embodiments, by regulating first and second ramp periods tᵣₐₘₚ₁ and tᵣₐₘₚ₂ according to the load current I_{L}.

A design method, for example, as disclosed in US Patent Application Publication 2025/0293616 A1, herein incorporated by reference in its entirety, may achieve soft switching in the inverter.

In an ARCP inverter (e.g., inverter 105), resonant current supplied by the auxiliary circuit is utilized to perform soft switching. However, parasitic capacitance from the electric machine 150 to a system ground (e.g., including a motor frame) may establish a common mode path, which may cause high frequency ripples in the load current I_{L}, which is usually in the range of several MHz. These high frequency ripples may affect the charging and discharging of resonant capacitors Cᵣ in the auxiliary circuit of the ARCP inverter, which may cause a soft switching failure. Some example embodiments include tuning methods for the resonant circuit and/or resonant current to reduce or eliminate soft switching failure.

Referring to FIG. 3B, to achieve soft switching, the resonant inductor Lᵣ₁ provides enough energy to the resonant capacitors Cᵣ₁ and Cᵣ₂ to accomplish the charging and discharging process. Since the resonant inductor current I_{Lr} and the load current I_{L} may have the same direction or opposite direction, two different cases of the inverter 105 not operating in a soft switching mode (e.g., operating in a hard switching mode) may occur.

Referring to FIG. 3B, Case 1 is defined when the resonant inductor current I_{Lr} has the same direction as the load current I_{L}. For example, in FIG. 3B, the load current I_{L} is shown as a negative current. Case 1 occurs between t5 and t10 where it can be seen that the resonant inductor current I_{Lr} changes from 0 to a negative current having an amplitude greater than the load current I_{L} and then returns to 0 at t10. Thus, between t5 and t10 the resonant inductor current I_{Lr} has the same direction as the load current I_{L}. During a first resonant interval tᵣₑₛ₁ it is required that |I_{Lr}|>|I_{L}| to achieve soft switching. A time duration tᵣₐₘₚ₁ is the duration to charge the resonant inductor Lr to reach the starting point of the resonant interval tᵣₑₛ₁. For example, at t7, I_{boost1} represents the difference between the resonant inductor current I_{Lr} and the load current I_{L} at t7.

Case 2 is defined when the resonant inductor current I_{Lr} has an opposite direction compared to the load current I_{L}. For example, in FIG. 3B, Case 2 occurs between t0 and t4 where it can be seen that the resonant inductor current I_{Lr} changes from 0 to a positive current and then returns to 0 at t4. Thus, between t0 and t4 the resonant inductor current I_{Lr} has an opposite direction compared to the load current I_{L}. At the starting point of the second resonant interval tᵣₑₛ₂, I_{boost2} is the difference between I_{Lr} and zero. The time duration t_{dead} is the required dead time between the switching actions for the main switches T₁ and T₂.

According to some example embodiments, in response to determining that the inverter 105 is operating in the hard switching mode (e.g., is not operating in the soft switching mode, such as Case 1 and/or Case 2) the controller 110 may adjust the inverter 105 to operate in the soft switching mode.

FIGS. 4A and 4B illustrate soft switching failure scenarios.

In order to achieve the soft switching, the resonant capacitor Cᵣ must be discharged before the corresponding switch T is turned on. The charge and discharge of the resonant capacitor Cᵣ is controlled by current I_{Cr}, which satisfies I_{Cr}=I_{Lr}−I_{L}.

Referring to FIG. 4A, due to high change in voltage over time dv/dt of the voltage V_{T2} across the main switch T₂ (e.g., during the dead time t_{dead}), the load current I_{L} has a high frequency current component, which comprises the commutating process as shown in FIG. 4A. In a first situation, shown in FIG. 4A, the load current I_{L} excited by the change in voltage dv/dt of voltage V_{T2} across the main switch T₂ leads to an incomplete resonant capacitor Cᵣ₂ discharge process. For example, the amplitude of the resonant current I_{Lr} is not high enough to discharge the voltage from the resonant capacitor Cᵣ₂. Therefore, the voltage V_{T2} across the main switch T₂ doesn't drop to 0V when the main switch T₂ turns on, leading to a zero voltage switching (AVS) turn on failure.

Referring to FIG. 4B, in a second situation shown in FIG. 4B, the load current I_{L} reverse charging point changes from P to P′, which is before main switch T₂ turns on. As a result, the resonant current is able to discharge the resonant capacitor Cᵣ initially. However, the resonant current I_{Lr} cannot clamp the zero voltage (e.g., maintain discharge of the resonant capacitor Cᵣ₂) during the whole deadtime t_{dead}. As a result, when a switching action happens, the ZVS moment is missed, resulting in soft switching failure.

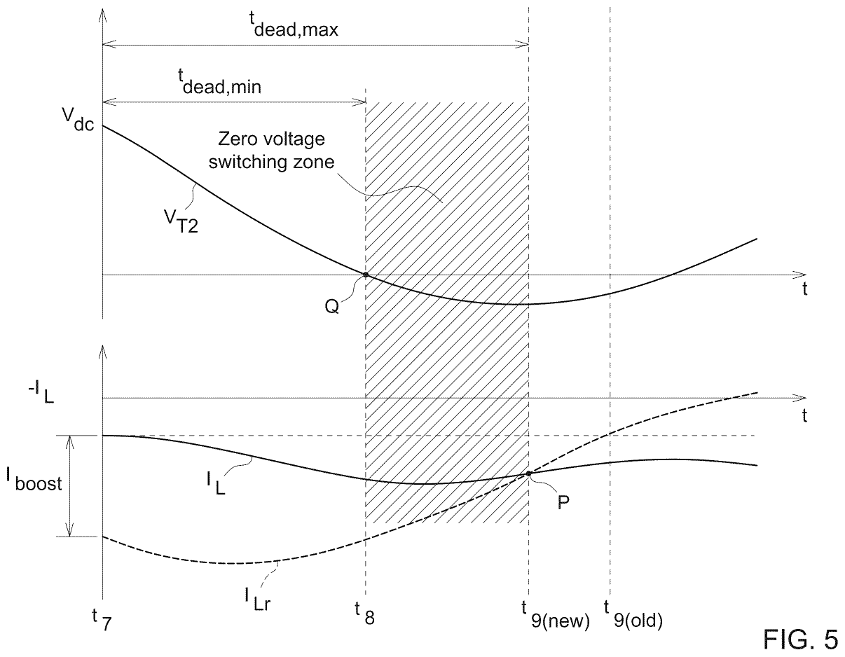

FIG. 5 shows a graph illustrating the commutation process shown in FIGS. 4A and 4B.

Referring to FIG. 5, point Q is where resonant capacitor Cᵣ₂ is fully discharged and point P is where reverse charging begins. Therefore, the switch T₂ should be turned on between t8 and t9 (new) so that the T₂ switch voltage V_{T2} ZVS can be reached.

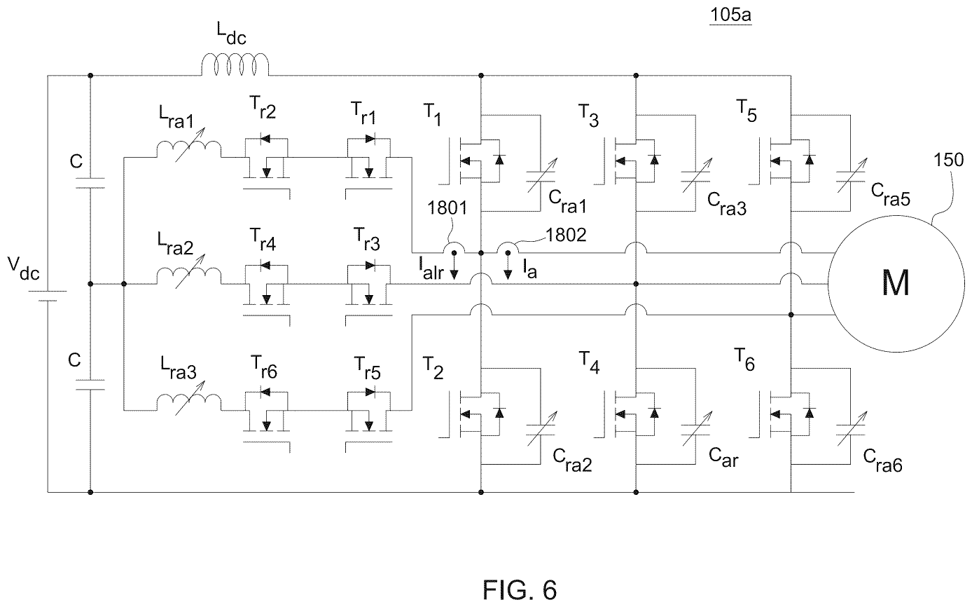

FIG. 6 illustrates a hybrid resonance circuit according to some example embodiments.

Referring to FIG. 6, inverter 105a may be similar to inverter 105 illustrated in FIG. 2. Therefore, only the differences will be explained. An inverter 105a implemented as a hybrid resonance circuit may include at least one of variable resonant inductors Lᵣₐ₁-Lᵣₐ₃ and/or variable resonant capacitors Cᵣₐ₁-Cᵣₐ₆ in place of the resonant inductors Lᵣ₁-Lᵣ₃ and/or the resonant capacitors Cᵣ₁-Cᵣ₆. For example, Drains of second switches Tᵣ₁, Tᵣ₃, and Tᵣ₅ are connected, respectively, to first terminals of resonant inductors Lᵣₐ₁, Lᵣₐ₂, and Lᵣₐ₃. A second terminal of resonant inductor Lᵣₐ₁ is connected to a source of first switch T₁ and a drain of second switch T₂. A second terminal of resonant inductor Lᵣₐ₂ is connected to a source of first switch T₃ and a drain of first switch T₄. A second terminal of resonant inductor Lᵣₐ₃ is connected to a source of first switch T₅ and a drain of first switch T₆. Each of first switches T₁-T₆ is connected in parallel to a respective resonant capacitor Cᵣₐ₁-Cᵣₐ₆. For example, a first terminal of each resonant capacitor Cᵣₐ₁-Cᵣₐ₆ is connected to a source of a respective first switch T₁-T₆ and a second terminal of each resonant capacitor Cᵣₐ₁-Cᵣₐ₆ is connected to a drain of the respective first switch T₁-T₆. Thus, a resonant capacitor Cᵣₐ is connected in parallel to each main switch T while a resonant inductor Lᵣₐ is connected between the auxiliary switches Tr and a middle point in each phase of the inverter 105a.

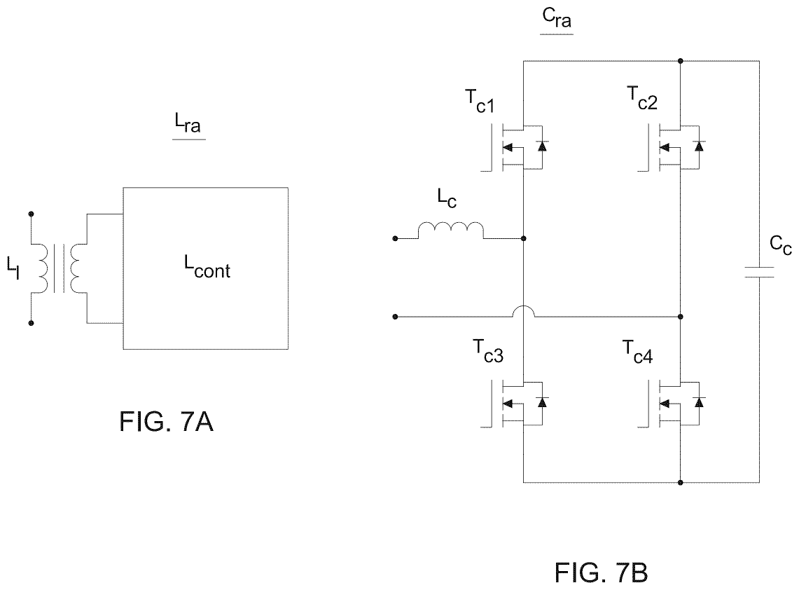

FIG. 7A illustrates an implementation of a variable resonant inductor according to example embodiments. FIG. 7B illustrates an implementation of a variable resonant capacitor according to example embodiments.

Referring to FIG. 7A, a variable resonant inductor Lᵣₐ includes an inductor Lₗ and an inductor controller L_{contr}. The inductor controller L_{contr} may be a pulse width modulation (PWM) controller. For example, the variable resonant inductor Lᵣₐ is realized using an inductor construction similar to two winding transformers wound on magnetic cores, where a primary winding is a variable inductor (e.g., inductor Lₗ) and a secondary winding is a pulse width modulator (PWM) (e.g., the inductor controller L_{contr}), resulting in the primary winding emulating functionality of a variable inductor. A PWM switching pattern of the secondary winding determines an inductance value of the variable inductor Lᵣₐ.

Referring to FIG. 7B, a variable resonant Capacitor Cᵣₐ includes an inductor L_{c}, a capacitor C_{c}, and first to fourth switches T_{C1}-T_{C4}. For example, a first terminal of the inductor L_{c} may be connected to a first input/output terminal of the variable resonant capacitor Cᵣₐ. A second terminal of the inductor L_{c} may be connected to a second input/output terminal of the variable resonant capacitor Cᵣₐ, a drain of first switch T_{c1}, a drain of second switch T_{c2}, a source of third switch T_{c3}, and a source of fourth switch T_{c4}. A first terminal of the capacitor C_{c} may be connected to a source of first switch T_{c1} and a source of second switch T_{c2}. A second terminal of the capacitor C_{c} may be connected to a drain of third switch T_{c3} and a drain of fourth switch T_{c4}.

Returning to FIG. 6, according to some example embodiments, the inverter 105a may include a resonant inductor current sensor 1801 configured to sense a resonant inductor current I_{aLr} of the inverter 105a and/or a phase output current sensor 1802 configured to sense an output current Iₐ of the electric machine 150 (e.g., a motor current). For example, the output current sensor 1801 may sense the resonant inductor current I_{aLr} of the auxiliary circuit of a first phase leg of the inverter 105a.

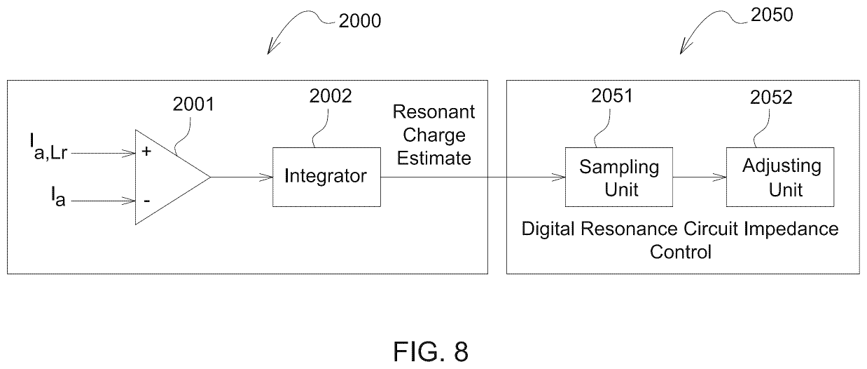

FIG. 8 illustrates a sensing circuit and a resonance impedance control unit according to example embodiments.

Referring to FIG. 8, a sensing circuit 2000 includes a comparator 2001 and an integrator 2002. A resonance impedance control unit 2050 includes a sampling unit 2051 and an adjusting unit 2052. In some example embodiments, the sensing circuit 2000 may be an analog sensing circuit. For example the analog sensing circuit 2000 may be a separate circuit from the controller 110. In some example embodiments, the sensing circuit 2000 and/or the resonance impedance control unit 2050 may be implemented by the controller 110.

By using an analog comparator 2001 and integrator 2002, it is possible to estimate the total charge of the resonance circuit during a switching event based on the resonant inductor current I_{aLr} of the inverter 105a and the output current Iₐ of the electric machine 150. For example, the comparator 2001 may take the resonant inductor current I_{aLr} and the output current Iₐ of the electric machine 150 as inputs and may output the difference between the phase output current Iₐ and the resonant inductor current I_{aLr} to the integrator 2002. The output of the integrator 2002 is an estimated total charge of the resonance circuit.

In order to achieve the full ZVS switching of the main switch T, the resonance charge must satisfy: Charge>2*Cr*V_{dc}. If the inverter cannot meet this condition during the operation, the controller 110 may adjust an inductance of variable resonant inductors Lᵣₐ and/or a capacitance of variable resonant capacitors Cᵣₐ impedance in real time to meet the ZVS condition.

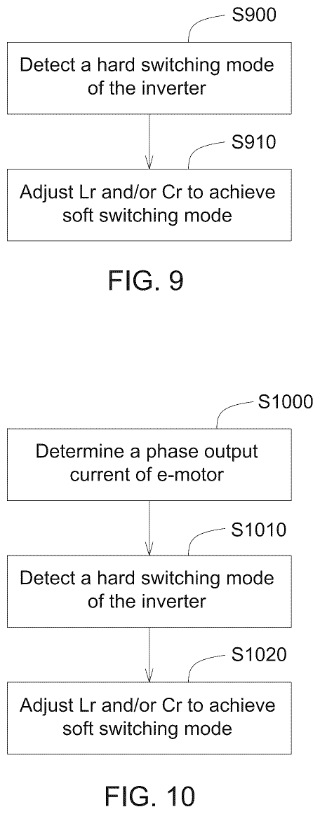

FIG. 9 is a flow chart illustrating a method of controlling the inverter 105a according to example embodiments. The method shown in FIG. 9 may be performed at the controller 110.

Referring to FIGS. 6 and 9, at S900 the controller 110 detects a hard switching mode of the inverter 105a. For example, the controller 110 may detect the hard switching mode based on at least one of a resonant inductor current I_{aLr} and/or an output current Iₐ. However, example embodiments are not limited to this example. In some example embodiments, the controller 110 may determine the hard switching based on a device voltage Vas of the inverter 105a. For example, the controller 110 may determine a voltage fall time T_{fall} based on the device voltage Vas and may determine the hard switching based on the voltage fall time T_{fall} being above a threshold. In some example embodiments, the controller 110 may determine the inverter 105a is operating in the hard switching mode based on a gate voltage of main switches T the inverter 105a. For example, the controller 110 may detect a Miller plateau phenomenon based on the gate voltage of the main switches T and determine that the inverter 105a is operating in the hard switching mode based on detecting the Miller plateau phenomenon. In some example embodiments, the controller 110 may determine the hard switching based on a temperature of the inverter 105a. For example, the controller 110 may determine the inverter 105a is operating in the hard switching mode in response to a temperature of the inverter 105a being above a threshold temperature.

At S910, the controller 110 adjusts at least one of a resonant capacitance and/or a resonant inductance of the inverter 105a. For example, the controller 110 may adjust an inductance of variable resonant inductors Lᵣₐ and/or a capacitance of variable resonant capacitors Cᵣₐ impedance to satisfy Charge>2*Cr*V_{dc} to achieve soft switching.

According to example embodiments, by detecting the hard switching mode and adjusting the inductance of variable resonant inductors Lᵣₐ and/or the capacitance of variable resonant capacitors Cᵣₐ impedance to achieve the soft switching, switching performed by the inverter 105a in the hard switching mode may be reduced and/or prevented and the inverter 105a may be operated in the soft switching mode. Accordingly, damage to the inverter 105a caused by the hard switching may be reduced and/or prevented and an operational lifespan of the inverter 105a may be increased.

FIG. 10 is a flow chart illustrating a method of controlling the inverter 105a according to example embodiments. The method shown in FIG. 10 may be performed at the controller 110.

Referring to FIGS. 6 and 10, at S1000 the controller 110 determines the phase output current Iₐ of the electric machine 150. For example, the controller 110 may detect the phase output current Iₐ via the phase output current sensor 1802.

At S1010 the controller 110 detects a hard switching mode of the inverter 105a based on the phase output current Iₐ. For example, the controller 110 may detect the hard switching mode based on at least one of the resonant inductor current I_{aLr} and/or the phase output current Iₐ. For example, as discussed in more detail below, the controller 110 may determine an average estimated total charge of the resonance circuit based on the resonant inductor current I_{aLr} and the phase output current Iₐ and may determine the hard switching mode based on the average estimated total charge of the resonance circuit. However, example embodiments are not limited to this example. In some example embodiments, as discussed in more detail below, the controller 110 may detect the hard switching mode by estimating a machine parasitic capacitance based on the phase output current Iₐ.

At S1020, the controller 110 adjusts at least one of a resonant capacitance and/or a resonant inductance of the inverter 105a. For example, the controller 110 may adjust an inductance of variable resonant inductors Lᵣₐ and/or a capacitance of variable resonant capacitors Cᵣₐ impedance to satisfy Charge>2*Cr*V_{dc} to achieve soft switching.

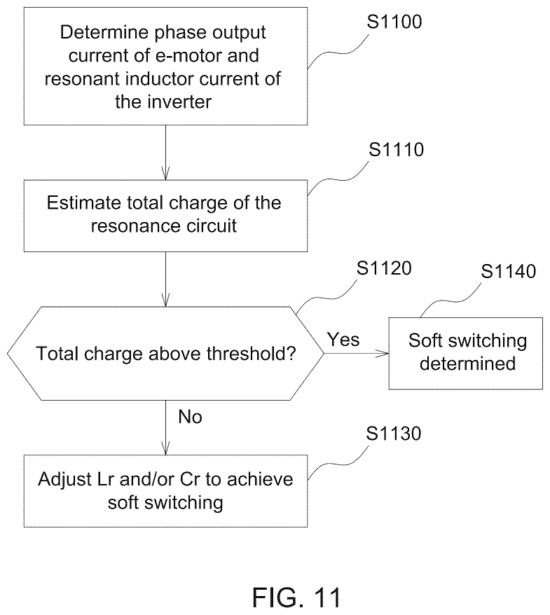

FIG. 11 is a flow chart illustrating a method of controlling the inverter 105a according to example embodiments. The method shown in FIG. 11 may be performed at the controller 110 implementing the resonance impedance control unit 2050.

Referring to FIGS. 6, 8, and 11, at S1100 the controller 110 determines a phase output current Iₐ of the electric machine 150 and a resonant inductor current I_{aLr} of the inverter 105a. For example, the controller 110 may detect the phase output current Iₐ via the phase output current sensor 1802 and may detect the resonant inductor current I_{aLr} via the resonant inductor current sensor 1801.

At S1110, the controller 110 estimates a total charge of the resonance circuit. For example, the controller 110 may estimate the total charge of the resonance circuit via the sensing circuit 2000. For example, the phase output current Iₐ and the resonant inductor current I_{aLr} may be input to the comparator 2001. The comparator 2001 outputs the difference between the phase output current Iₐ and the resonant inductor current I_{aLr} to the integrator 2002. The difference between the phase output current Iₐ and the resonant inductor current I_{aLr} may be a capacitor current I_{cap} of the inverter 105a. The output of the integrator 2002 is an estimated total charge of the resonance circuit. For example, the integrator 2002 may determine the estimated total charge of the resonance circuit as

$${\int }_{t}^{t + {T}_{s}} {I}_{cap} d t .$$

The controller may sample the estimated total charge of the resonance circuit via the sampling unit 2051 to determine an estimated amount of energy required to be delivered by the auxiliary circuit to achieve soft switching. The sampling time should be similar to or faster than the switching frequency of the inverter 105a so that the sampling unit 2051 may determine the estimated amount of energy once per switching period.

At S1120, the controller 110 determines whether the estimated total charge of the resonance circuit (e.g., an average estimated total charge of the resonance circuit) is above a threshold. In order to achieve soft switching of the main switches Tᵣ₁-T₆, the total charge of the resonance circuit must be greater than 2*Cᵣ*V_{dc}. If the estimated total charge of the resonance circuit is above the threshold (YES at S1120) the method proceeds to S1140.

At S1140, the controller determines that the inverter 105a is in the soft switching mode and does not alter the capacitance of the variable capacitors Cᵣₐ and/or the inductance of the variable inductors Lᵣₐ.

Returning to S1120, if the estimated total charge of the resonance circuit is not above the threshold (NO at S1120) the method proceeds to S1130.

At S1130, the controller adjusts at least one of the capacitance of the variable capacitors Cᵣₐ and/or the inductance of the variable inductors Lᵣₐ so that the total charge of the resonance circuit of the inverter 105a is greater than 2*Cᵣ*V_{dc} to achieve soft switching in the inverter 105a. For example, the controller 110 may adjust the inductance of variable resonant inductors Lᵣₐ and/or the capacitance of variable resonant capacitors Cᵣₐ via the adjusting unit 2052.

An advantage of the example embodiments of FIG. 11 is that the sampling requirement (e.g., processing power of the controller 110 used to perform the method) is relatively low. However, two current sensors 1801 and 1802 are needed.

In some example embodiments, the method shown in FIG. 11 may be performed once during pre-power diagnosis of the electric drive 10 and not performed again during operation of the electric drive 10. However, example embodiments are not limited to this example, and the method may be performed multiple times during operation of the electric drive 10.

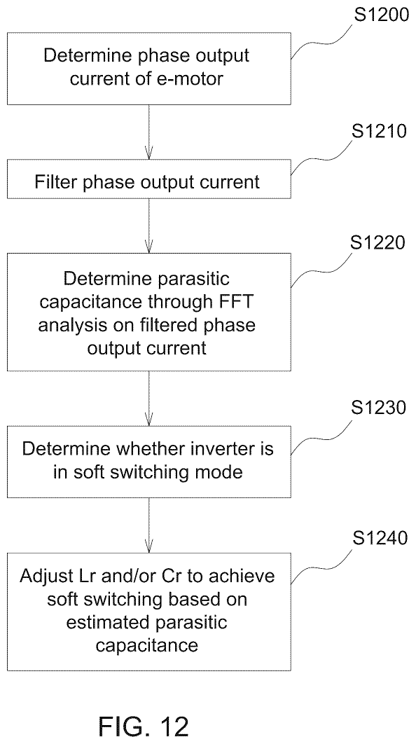

FIG. 12 is a flow chart illustrating a method of controlling the inverter 105a according to example embodiments. The method shown in FIG. 12 may be performed at the controller 110.

Referring to FIGS. 6 and 12, at S1200 the controller 110 determines the phase output current Iₐ of the electric machine 150. For example, the controller 110 may detect the phase output current Iₐ via the phase output current sensor 1802 in real time. For example, if the phase output current is at 100 Hz, then a sampling frequency of the phase output current sensor 1802 is be about 1000 Hz.

At S1210, the controller 110 filters the sampled phase output current Iₐ.

Due to the parasitic capacitance from the electric machine 150, the output current Iₐ may contain a high-frequency ripple. The ripple current may impact the operation of the Lᵣₐ-Cᵣₐ resonance circuit inside the soft-switching inverter 105a and eventually lead to ZVS failure, as discussed with reference to FIGS. 4A and 4B. For example, referring to FIG. 4A, in Case 1 the resonant circuit of the inverter 105a may not have enough charge to discharge the resonant capacitors Cᵣₐ, and, referring to FIG. 4B, in a Case 2 the resonant circuit of the inverter 105a may not have enough charge to maintain the zero voltage across the resonant capacitors Cᵣₐ during the dead time t_{dead}.

The controller 110 may filter the phase output current Iₐ using a high-pass filter. For example, the controller 110 may use the high-pass filter to filter out the high-frequency ripple. The phase output current Iₐ includes a fundamental current (power current) and a high frequency ripple. The high-pass filter may remove the fundamental current, leaving only the high frequency ripple current from the phase output current Iₐ.

At S1220, the controller 110 performs a Fast Fourier Transform (FFT) analysis on the filtered phase output current Iₐ (e.g., on the high frequency ripple current from the phase output current Iₐ) to determine a parasitic capacitance C_{parasitic} of the electric machine 150. For example, the FFT analysis may find a main frequency fₘₐᵢₙ of the filtered current according to Equation 1, where fₘₐᵢₙ is measured in Hz and C_{parasitic} is the parasitic capacitance posed by the power circuit at the output of the inverter 105a, which includes a connector, cable, and electric machine 150.

### Equation 1

$${f}_{main = \frac{1}{2 π \sqrt{{L}_{r} ( 2 {C}_{r} + {C}_{parasitic} )}}}$$

At S1230, the controller 110 determines whether the inverter 105a is in the soft switching mode based on the estimated parasitic capacitance.

At S1240, the controller 110 adjusts at least one of the capacitance of the variable capacitors Cᵣₐ and/or the inductance of the variable inductors Lᵣₐ, based on the estimated parasitic capacitance, to achieve soft switching. For example, the controller 110 may adjust at least one of the capacitance of the variable capacitors Cᵣₐ and/or the inductance of the variable inductors Lᵣₐ according to a look-up table. In some example embodiments, the controller 110 may use a hunting method to adjust the variable capacitors Cᵣₐ and/or the inductance of the variable inductors Lᵣₐ to achieve soft switching. For example, the controller 110 may incrementally adjust the capacitance of the variable capacitors Cᵣₐ and/or the inductance of the variable inductors Lᵣₐ until the estimated parasitic capacitance indicates that soft-switching is achieved. For example, the controller may adjust a ratio of the capacitance of the variable capacitors Cᵣₐ to the inductance of the variable inductors Lᵣₐ more than 4× per increment, where the capacitance is in nano Farad and the inductance is in micro Henry.

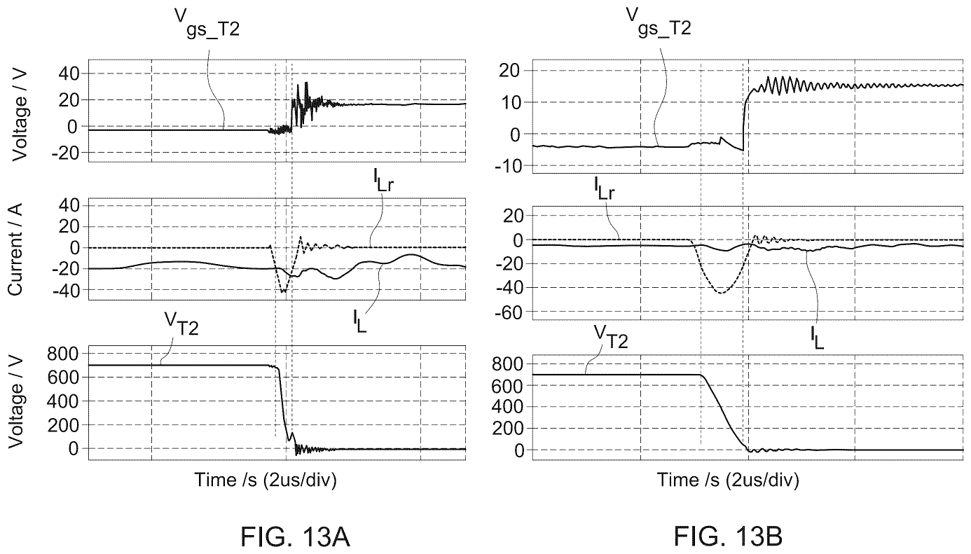

FIG. 13A illustrates a soft switching failure caused by a high-frequency current ripple from parasitic capacitance of the electric machine 150. As shown in FIG. 13A, the resonance current I_{Lr} includes a ripple from the parasitic capacitance causing a ZVS failure. For example, as shown in FIG. 13A, a soft-switching failure may cause oscillations in the gate voltage V_{gs_T2}. The oscillations in the gate voltage V_{gs_T2} may be detected via a sensor to detect soft-switching failures.

FIG. 13B illustrates a resonant current covering the high-frequency current ripple by adjusting at least one of the capacitance of the variable capacitors Cᵣₐ and/or the inductance of the variable inductors Lᵣₐ according to the method of FIG. 12.

An advantage of the example embodiments of FIG. 12 is that only one current sensor is needed. However, the computational requirement of the controller 110 may be relatively larger than, for example, example embodiments according to FIG. 11.

In some example embodiments, the method shown in FIG. 12 may be performed once during pre-power diagnosis of the electric drive 10 and not performed again during operation of the electric drive 10. This may mitigate the relatively larger computational requirement. However, example embodiments are not limited to this example, and the method may be performed multiple times during operation of the electric drive 10.

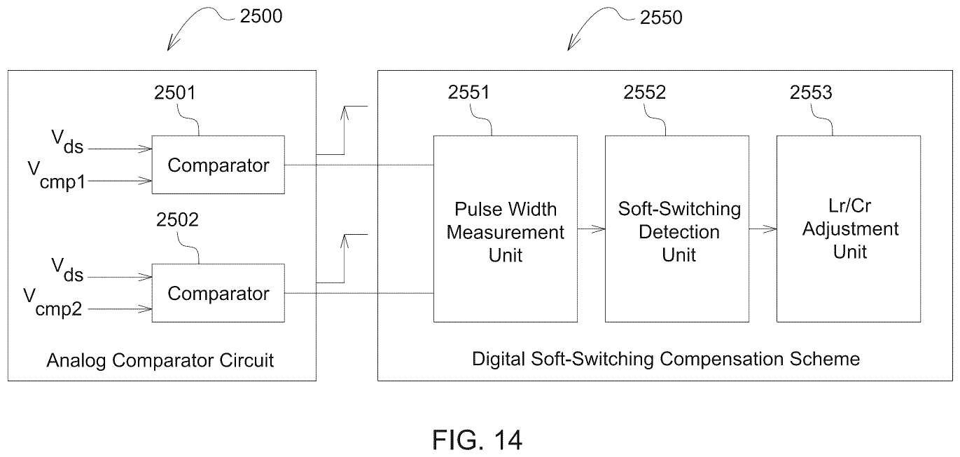

FIG. 14 illustrates a comparator circuit and a soft switching compensation unit according to example embodiments.

Referring to FIG. 14, a comparator circuit 2500 includes a first comparator 2501 and a second comparator 2502. A soft switching compensation unit 2550 includes a pulse and width measurement unit 2551, a soft switching detection unit 2552, and a Lᵣ/Cᵣ adjustment unit 2553. The pulse and width measurement unit 2551 may determine a voltage fall time T_{fall} based on crossing times output by the first and second comparators 2501 and 2502. The soft switching detection unit 2552 may determine whether the inverter 105a is in the soft switching mode by comparing the T_{fall} time to a threshold. The adjusting unit 2052 may adjust the inductance of variable resonant inductors Lᵣₐ and/or the capacitance of variable resonant capacitors Cᵣₐ so that the inverter 105a operates in the soft switching mode. In some example embodiments, the comparator circuit 2500 may be an analog comparator circuit. For example, the analog comparator circuit 2500 may be a separate circuit from the controller 110. In some example embodiments, the comparator circuit 2500 and/or the soft switching compensation unit 2550 may be implemented by the controller 110.

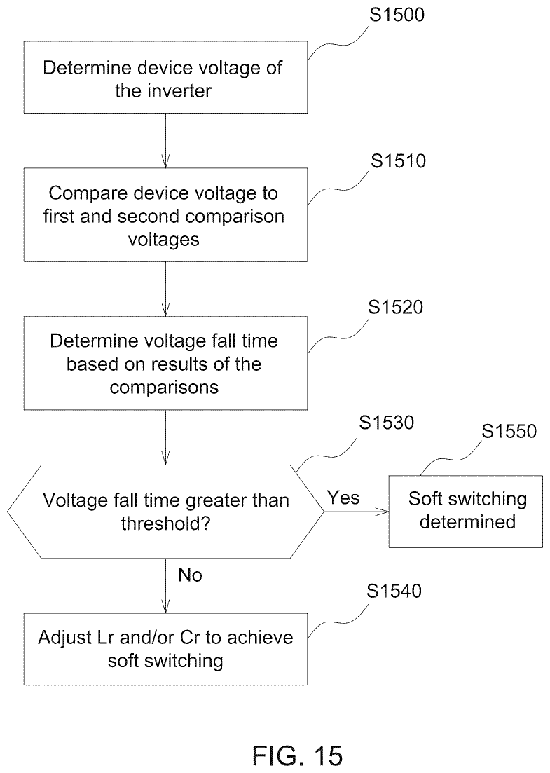

FIG. 15 is a flow chart illustrating a method of controlling the inverter 105a according to example embodiments. The method shown in FIG. 15 may be performed at the controller 110 implementing the soft switching compensation unit 2550.

Referring to FIGS. 6, 14, and 15, at S1500 the controller 110 determines a device voltage Vas of the inverter 105a. In some example embodiments, the controller 110 may know the device voltage Vas. In some example embodiments, the controller 110 may determine the device voltage Vas via a voltage sensor. For example, the device voltage may be measured using a network (time) compensated circuit across drain and source terminals of switches T₁-T₆ of the inverter 105a.

At S1510, the controller 110 compares the device voltage Vas to a first comparison voltage V_{cmp1} and a second comparison voltage V_{cmp2}. For example, the controller 110 may compare the device voltage Vas to the first comparison voltage V_{cmp1} via the first comparator 2501 and may compare the device voltage Vas to the second comparison voltage V_{cmp2} via the second comparator 2502.

The first comparator 2501 outputs a crossing time when the device voltage V_{ds} is the same as the first comparison voltage V_{cmp1} and the second comparator 2502 outputs a crossing time when the device voltage Vas is the same as the second comparison voltage V_{cmp2}. For example, the comparators 2501 and 2502 may perform comparisons at twice the rate of a switching frequency of the inverter 105a. For example, the comparators 2501 and 2502 may output the crossing times when the device voltage Vas falls from a high voltage to a low voltage.

At S1520, the controller determines a voltage fall time T_{fall} based on the crossing times output by the first and second comparators 2501 and 2502. The voltage fall time may indicate a time point when the device voltage Vas of the inverter 105a is within a threshold voltage above or below zero volts. According to some example embodiments, the controller 110 may determine the voltage fall time T_{fall} via the pulse and width measurement unit 2551. The voltage fall time T_{fall} is the time it takes for the device voltage Vas to drop from the first comparison voltage V_{cmp1} to the second comparison voltage V_{cmp2}.

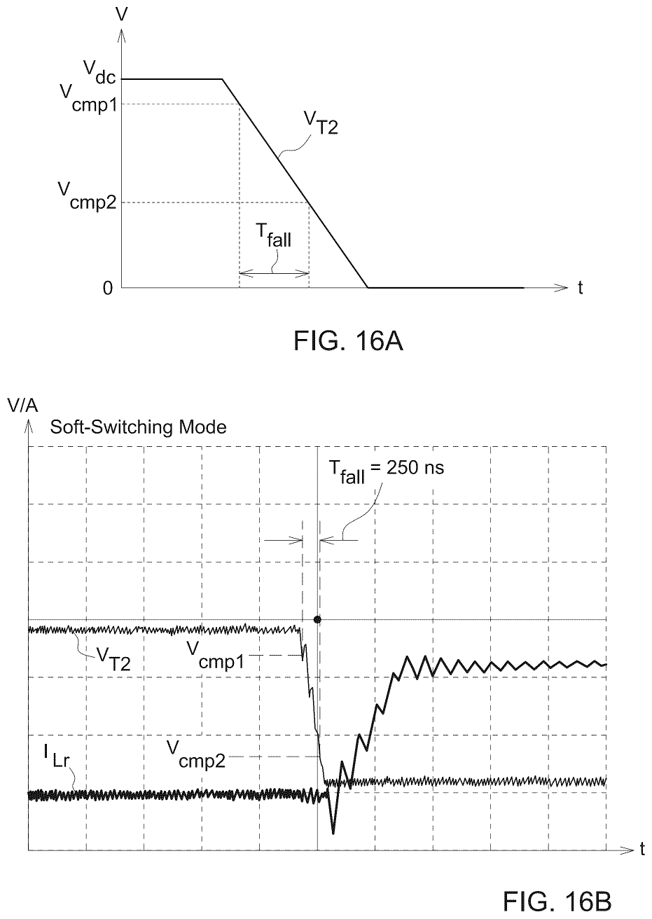

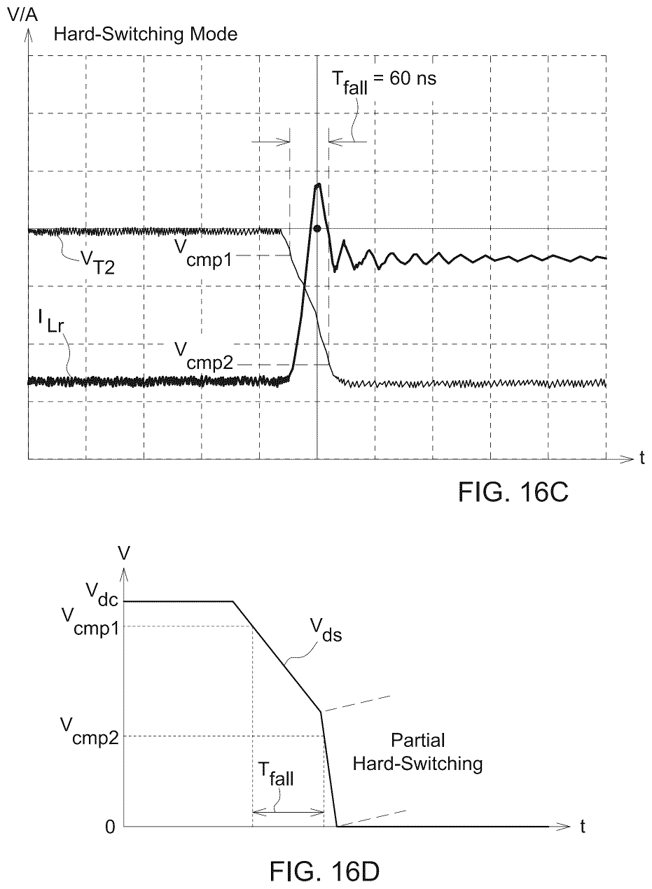

FIGS. 16A and 16B are graphs illustrating a voltage fall time in a soft switching mode. FIG. 16C illustrates the voltage fall time in a hard switching mode. FIG. 16D illustrates the voltage fall time in a partial soft switching mode.

Referring to FIGS. 16A, 16B, and 16C, in the soft switching mode the voltage fall time is much larger than that in the hard-switching mode. For example, FIG. 16B illustrates an example in which the voltage fall time T_{fall} is 250 ns in the soft switching mode and FIG. 16C illustrates an example in which the fall time T_{fall} is 60 ns in the hard switching mode.

Returning to FIG. 15, at S1530 the controller 110 determines whether the voltage fall time T_{fall} is above a threshold time. For example, the controller 110 may determine whether the voltage fall time T_{fall} is above the threshold time via the soft switching detection unit 2552. For example, the threshold time may be 100 ns. However, example embodiments are not limited to this example and the threshold time may be greater than or less than 100 ns. If the voltage fall time T_{fall} is greater than the threshold time (YES at S1530), then the method proceeds to S1550.

At S1550, the controller 110 determines that the inverter 105a is in the soft switching mode and does not alter the capacitance of the variable capacitors Cᵣₐ and/or the inductance of the variable inductors Lᵣₐ.

Returning to S1530, if the voltage fall time T_{fall} is not greater than the threshold time (NO at S1530), the method proceeds to S1540.

At S1540, the controller 110 adjusts at least one of the capacitance of the variable capacitors Cᵣₐ and/or the inductance of the variable inductors Lᵣₐ to achieve soft switching. For example, the controller 110 may adjust at least one of a resonance capacitance and/or resonance inductance of the inverter 105a to cover the high-frequency current ripple via the Lᵣ/Cᵣ adjustment unit 2553. For example, the controller may determine to adjust the Lᵣ/Cᵣ based on a difference between the output of the first comparator and the second comparator and a lookup table. However, example embodiments are not limited to this example. In some example embodiments, the controller 110 may use a hunting method to adjust the variable capacitors Cᵣₐ and/or the inductance of the variable inductors Lᵣₐ to achieve soft switching. For example, the controller 110 may incrementally adjust the capacitance of the variable capacitors Cᵣₐ and/or the inductance of the variable inductors Lᵣₐ until the voltage fall time T_{fall} is greater than the threshold. For example, the controller may adjust a ratio of the capacitance of the variable capacitors Cᵣₐ to the inductance of the variable inductors Lᵣₐ more than 4× per increment, where the capacitance is in nano Farad and the inductance is in micro Henry.

Referring to FIGS. 16A and 16D, in a partial soft switching mode, as illustrated in FIG. 16D, the pulse width will be narrower compared to a pulse width in the complete soft-switching mode illustrated in FIGS. 16A and 16B. When the inverter 105a is in the soft switching mode, the baseline pulse width would be the widest pulse shown in FIG. 16B. When the pulse narrows, the method shown in FIG. 15 and described above may detect a failure in the soft switching. Thus, the method shown in FIG. 15 may detect the partial hard switching mode as well as the hard switching mode and may adjust the inverter 105a to perform the soft switching in response to detecting the partial hard switching mode and/or the hard switching mode.

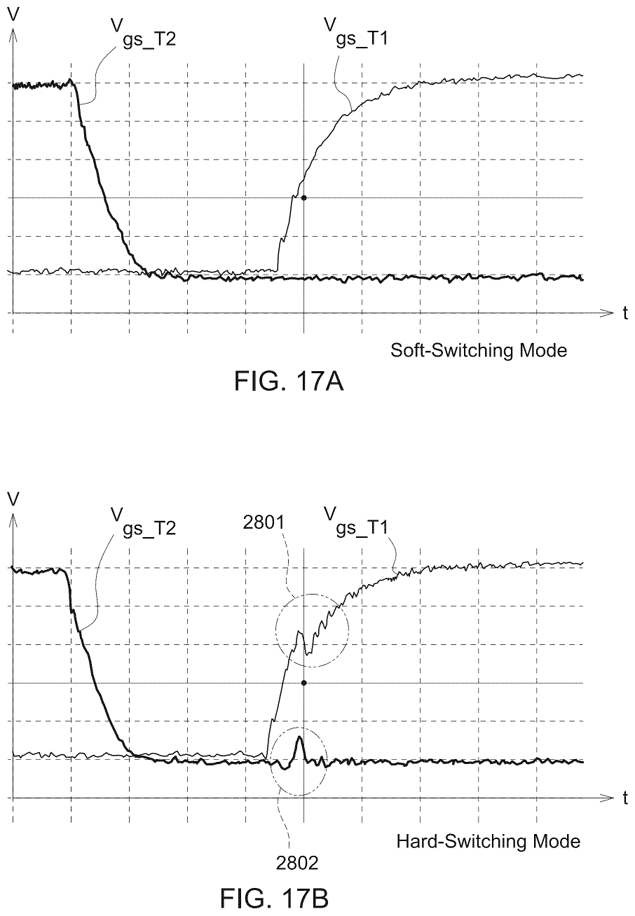

FIG. 17A is a graph illustrating gate-source voltages V_{gs_T1} and V_{gs_T2} of complimentary main switches T₁ and T₂ when the inverter 105a is in a soft switching mode. FIG. 17B is a graph illustrating gate-source voltages V_{gs_T1} and V_{gs_T2} of complimentary main switches T₁ and T₂ when the inverter 105a is in a hard switching mode.

Referring to FIGS. 17A and 17B, when the inverter 105a is in the soft switching mode, as shown in FIG. 17A, the voltage graphs V_{gs_T1} of the gate voltage of main switch T₁ and V_{gs_T2} of the gate voltage of main switch T₂ do not exhibit a Miller plateau phenomenon. However, when the inverter 105a is in the hard switching mode, as shown in FIG. 17B, the voltage graph V_{gs_T1} of the gate voltage of main switch T₁ exhibits the Miller plateau phenomenon. For example, as shown in FIG. 17B, a kink formation 2801 of a Miller plateau is exhibited due to hard switching. Additionally, the hard switching may lead to electromagnetic interference and may impact the circuit nominal operation of the inverter 105a. For example, as shown in FIG. 17B, the voltage graph V_{gs_T2} of the gate voltage of main switch T₂ exhibits crosstalk interference due to a hard switching turn on event. According to some example embodiments, the controller 110 may detect hard switching by detecting the Miller plateau phenomenon of the gate voltages V_{g}s of the main switches.

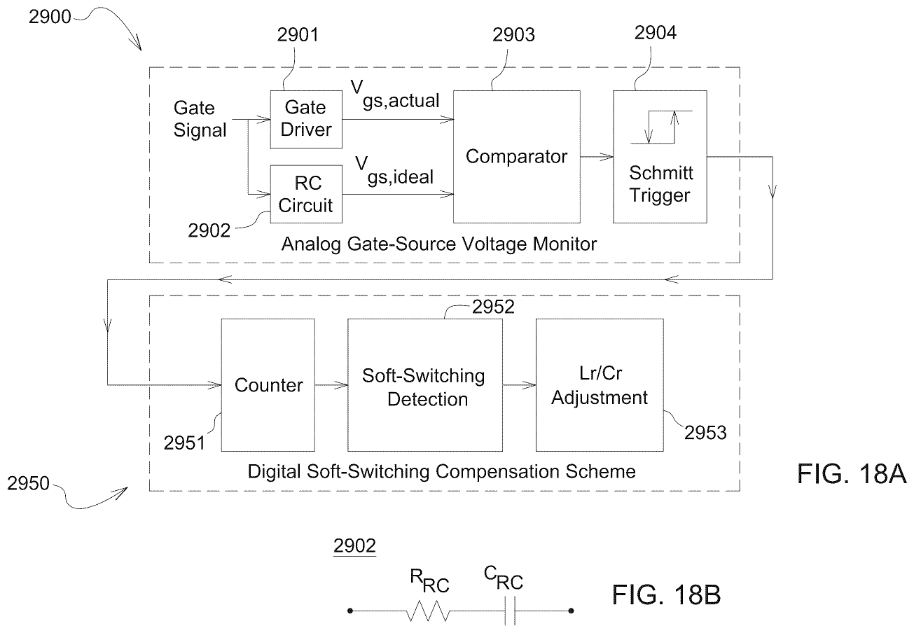

FIG. 18A illustrates a voltage monitor circuit and a soft switching compensation unit according to example embodiments.

Referring to FIG. 18A, a voltage monitor circuit 2900 includes a gate driver 2901, an RC circuit 2902, a comparator 2903, and a Schmitt trigger 2904. A soft switching compensation unit 2950 includes a counter 2951, a soft switching detection unit 2952, and a Lᵣ/Cᵣ adjustment unit 2953. The counter 2951 may count a number of outputs from the Schmitt trigger 2904. The soft switching detection unit 2952 may determine whether the inverter 105a is in the soft switching mode based on the number of outputs counted by the counter. For example, the soft switching detection unit 2952 may determine that the inverter is in the hard switching mode in response the number of outputs counted by the counter being greater than 0. The Lᵣ/Cᵣ adjustment unit 2953 may adjust the inductance of variable resonant inductors Lᵣₐ and/or the capacitance of variable resonant capacitors Cᵣₐ so that the inverter 105a operates in the soft switching mode. In some example embodiments, the voltage monitor circuit 2900 may be an analog voltage monitor circuit. For example the analog voltage monitor circuit 2900 may be a separate circuit from the controller 110. In some example embodiments, the voltage monitor circuit 2900 and/or the soft switching compensation unit 2950 may be implemented by the controller 110.

FIG. 18B illustrates an RC circuit according to example embodiments.

Referring to FIG. 18B, the RC circuit 2902 may include a resistor RRC having a resistance equal to a resistance of the gate of the main switch T₁ and/or T₂ and a capacitor CRC having a capacitance equal to a capacitance of the gate of the main switch T₁ and/or T₂ connected in series.

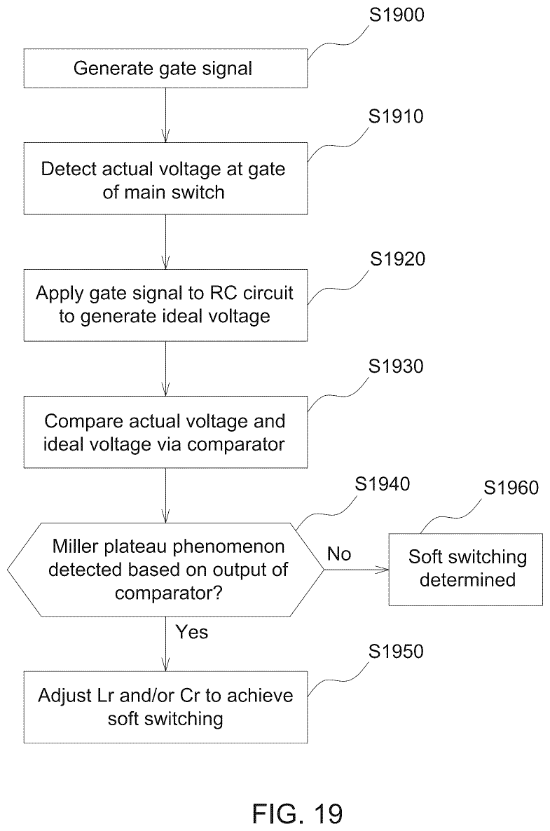

FIG. 19 is a flow chart illustrating a method of controlling the inverter 105a according to example embodiments. The method shown in FIG. 19 may be performed at the controller 110 implementing the soft switching compensation unit 2950.

Referring to FIGS. 6, 18, and 19, at S1900, the controller 110 generates a gate signal for controlling at least one of main switches T₁ and/or T₂. For example, the controller 110 may generate the gate signal via the gate driver 2901.

At S1910, the controller 110 detects an actual voltage V_{gs, actual} at the gate of the main switch T₁ and/or T₂. For example, the comparator may detect the actual voltage V_{gs, actual} via a voltage sensor at a gate of the main switch T₁ and/or T₂.

At S1920, the controller 110 generates an ideal voltage V_{gs, ideal}. For example, the controller 110 may generate the ideal voltage V_{gs, ideal} by applying the gate signal to RC circuit 2902. The RC circuit 2902 may be configured to generate the ideal gate voltage V_{gs, ideal} equal to a gate voltage of the main switch T₁ and/or T₂ if the inverter is operating in the soft switching mode based on an input gate driving signal.

At S1930, the controller compares the actual voltage V_{gs, actual} measured at the gate of the transistor T₁ and/or T₂ with the ideal voltage V_{gs, ideal} output from the RC circuit 2902. For example, the controller may compare the actual voltage V_{gs, actual} with the ideal voltage V_{gs, ideal} via the comparator 2903. The comparator 2903 may take the actual voltage V_{gs, actual} and the ideal voltage V_{gs, ideal} as inputs and may output a difference between the actual voltage V_{gs, actual} and the ideal voltage V_{gs, ideal}.

At S1940, the controller 110 determines whether a Miller plateau phenomenon is present based on the output of the comparator. For example, if the difference between the actual voltage V_{gs, actual} and the ideal voltage V_{gs, ideal} is not 0 (or is not within a threshold value from 0), then the controller 110 may determine that the Miller plateau phenomenon is present.

In some example embodiments, the output of the comparator 2903 may be input to a Schmitt trigger 2904. The Schmitt trigger 2904 may output a signal in response to the difference between the actual voltage V_{gs, actual} and the ideal voltage V_{gs, ideal} being a value other than 0. The controller 110 may count a number of signals output by the Schmitt trigger via, for example, the counter 2951.

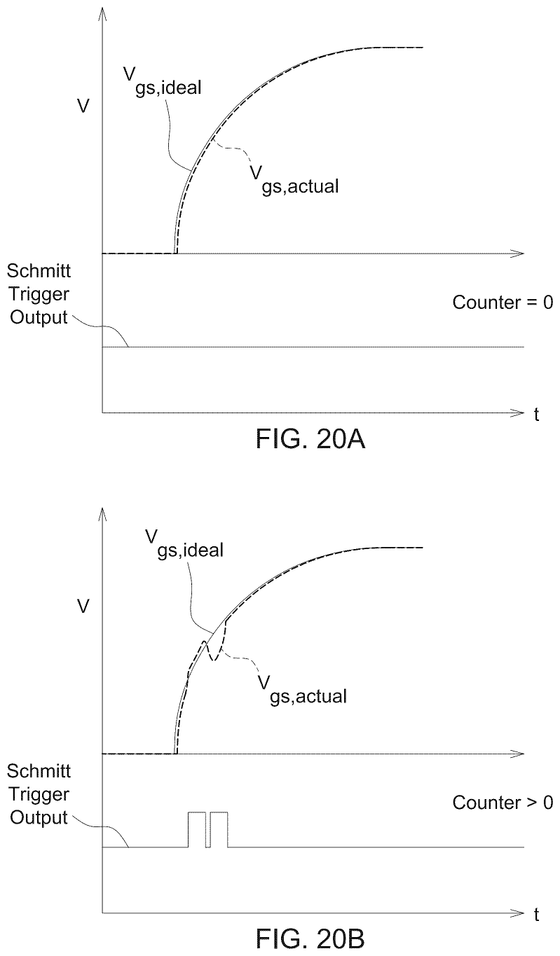

FIG. 20A is a graph showing voltages measured at agate of the main switch T₁ and/or T₂ and output from the RC circuit 2902 along with outputs from the Schmitt trigger 2904 and the counter 2951 in the soft switching mode. FIG. 20B is a graph showing voltages measured at the gate of the main switch T₁ and/or T₂ and output from the RC circuit 2902 along with outputs from the Schmitt trigger 2904 and the counter 2951 in the hard switching mode.

Referring to FIG. 20A, in the soft switching mode, the actual voltage V_{gs, actual} and the ideal voltage V_{gs, ideal} may be the same and the Schmitt trigger 2904 may output a constant low signal. The counter 2951 may not count any outputs (e.g., high output) from the Schmitt trigger 2904, and the counter value may be equal to 0.

Referring to FIG. 20B, in the hard switching mode, the actual voltage V_{gs, actual} and the ideal voltage V_{gs, ideal} may not be the same. When the output of the actual voltage V_{gs, actual} and the ideal voltage V_{gs, ideal} is not the same, the Schmitt trigger 2904 may output a high signal. For example, FIG. 20B shows the Schmitt trigger outputting a high signal two times during the period in which the actual voltage V_{gs, actual} and the ideal voltage V_{gs, ideal} are not the same voltage. As shown in FIG. 20B, the counter 2951 may count the number of high outputs from the Schmitt trigger as being greater than 0.

Returning to S1940, if the controller 110 determines that the Miller plateau phenomenon is not present, for example, by determining via the soft switching detection unit 2952 that the counter value is equal to 0 (NO at S1940), then the method proceeds to S1960.

At S1960, the controller determines that the inverter 105a is in the soft switching mode and does not alter the capacitance of the variable capacitors Cᵣₐ and/or the inductance of the variable inductors Lᵣₐ.

Returning to S1940, if the controller 110 determines that the Miller plateau phenomenon is present, for example, by determining via the soft switching detection unit 2952 that the counter value is greater than 0 (YES at S1940), then the method proceeds to S1950.

At S1950, the controller 110 adjusts at least one of the capacitance of the variable capacitors Cᵣₐ and/or the inductance of the variable inductors Lᵣₐ to achieve soft switching. For example, the controller 110 may adjust the capacitance of the variable capacitors Cᵣₐ and/or the inductance of the variable inductors Lᵣₐ according to a lookup table. However, example embodiments are not limited to this example. In some example embodiments, the controller 110 may use a hunting method to adjust the variable capacitors Cᵣₐ and/or the inductance of the variable inductors Lᵣₐ to achieve soft switching. For example, the controller 110 may incrementally adjust the capacitance of the variable capacitors Cᵣₐ and/or the inductance of the variable inductors Lᵣₐ until the Miller plateau phenomenon is not present, indicating that soft-switching is achieved. For example, the controller may adjust a ratio of the capacitance of the variable capacitors Cᵣₐ to the inductance of the variable inductors Lᵣₐ more than 4× per increment, where the capacitance is in nano Farad and the inductance is in micro Henry.

An electric drive according to example embodiments includes an inverter and processing circuitry configured to cause the electric drive to adjust at least one of a resonant capacitance or a resonant inductance of the inverter to cause the inverter to operate in a soft switching mode, in response to the inverter being in a hard switching mode.

In at least some example embodiments, the processing circuitry is further configured to cause the electric drive to determine a phase output current of an electric motor and detect the hard switching mode of the inverter based on the phase output current.

In at least some example embodiments, the processing circuitry is further configured to cause the electric drive to determine a resonant inductor current of the inverter and detect the hard switching mode based on the resonant inductor current and the phase output current.

In at least some example embodiments, the processing circuitry is further configured to cause the electric drive to estimate a total charge of a resonance circuit of the inverter based on the resonant inductor current and the phase output current and detect the hard switching mode based on the estimated total charge.

In at least some example embodiments, the processing circuitry is further configured to cause the electric drive to estimate a total charge of a resonance circuit of the inverter by determining a difference between the resonant inductor current and the phase output current and integrating the difference, and detect the hard switching mode based on based on the estimated total charge.

In at least some example embodiments, the processing circuitry is further configured to cause the electric drive to adjust the at least one of the resonant capacitance or the resonant inductance of the inverter such that a total charge of a resonance circuit of the inverter is greater than the value of a voltage of a DC power source of the inverter multiplied by the resonant capacitance of the inverter.

In at least some example embodiments, the processing circuitry is further configured to cause the electric drive to adjust the at least one of the resonant capacitance or the resonant inductance of the inverter such that a total charge of a resonance circuit of the inverter is greater than twice the value of a voltage of a DC power source of the inverter multiplied by the resonant capacitance of the inverter.

In at least some example embodiments, the processing circuitry is further configured to cause the electric drive to adjust the at least one of the resonant capacitance or the resonant inductance of the inverter in response to a total charge of a resonance circuit of the inverter being below a threshold value.

In at least some example embodiments, the processing circuitry is further configured to cause the electric drive to detect the hard switching mode of the inverter based on a device temperature of the inverter.

In at least some example embodiments, the processing circuitry is further configured to cause the electric drive to adjust the at least one of the resonant capacitance or the resonant inductance of the inverter based on an estimated machine parasitic capacitance of the electric motor.

In at least some example embodiments, the processing circuitry is further configured to cause the electric drive to generate the estimated machine parasitic capacitance by filtering the phase output current using a high pass filter and performing a fast Fourier transform (FFT) analysis on the filtered phase output current.

In at least some example embodiments, the processing circuitry is further configured to cause the electric drive to adjust at least one of the resonant capacitance or the resonant inductance of the inverter based on the estimated machine parasitic capacitance and a lookup table.

In at least some example embodiments, the processing circuitry is further configured to cause the electric drive to determine a voltage fall time of the inverter and detect the hard switching mode based on the voltage fall time.

In at least some example embodiments, the processing circuitry is further configured to cause the electric drive to determine the hard switching mode in response to the voltage fall time being below a threshold time.

In at least some example embodiments, the processing circuitry is further configured to cause the electric drive to determine the voltage fall time by determining a first crossing time when a device voltage of the inverter is equal to a first comparison voltage, determining a second crossing time when the device voltage of the inverter is equal to a second comparison voltage, and determining the voltage fall time based on the first crossing time and the second crossing time.

In at least some example embodiments, the voltage fall time corresponds with a time point when a device voltage of the inverter is within a threshold voltage above or below zero volts.

In at least some example embodiments, the processing circuitry is further configured to cause the electric drive to detect the hard switching mode based on a gate signal of the inverter.

In at least some example embodiments, the processing circuitry is further configured to cause the electric drive to detect a Miller plateau phenomenon based on the gate signal and determine the hard switching mode in response to detecting the Miller plateau phenomenon.

In at least some example embodiments, the processing circuitry is further configured to cause the electric drive to determine a difference between an actual voltage of the gate signal and an ideal voltage of the gate signal and detect the Miller plateau phenomenon based on the difference.

A method of controlling an electric drive according to example embodiments includes adjusting at least one of a resonant capacitance or a resonant inductance of an inverter to cause the inverter to operate in a soft switching mode, in response to the inverter being in a hard switching mode.

At least one example embodiment provides a non-transitory computer readable storage medium storing computer executable instructions that, when executed, cause a device to perform a method of controlling an electric drive according to example embodiments includes adjusting at least one of a resonant capacitance or a resonant inductance of an inverter to cause the inverter to operate in a soft switching mode, in response to the inverter being in a hard switching mode.

At least one example embodiment provides a device for controlling an electronic drive, the device including a means for adjusting at least one of a resonant capacitance or a resonant inductance of an inverter to cause the inverter to operate in a soft switching mode, in response to the inverter being in a hard switching mode.

G. Tabrizi, F. Schnabel and M. Jung, “Optimized Design Method and Control of an Auxiliary Resonant Commutated Pole Inverter for Two Level Photovoltaic Inverters,” PCIM Europe digital days 2021; International Exhibition and Conference for Power Electronics, Intelligent Motion, Renewable Energy and Energy Management, Online, 2021, pp. 1-8 and A. Charalambous, X. Yuan and N. McNeill, “High-Frequency EMI Attenuation at Source With the Auxiliary Commutated Pole Inverter,” in IEEE Transactions on Power Electronics, vol. 33, no. 7, pp. 5660-5676, July 2018 discuss parameter optimization in soft switching inverters, the contents of each of with are herein incorporated by reference in their entireties.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed:

1. An electric drive comprising:
an inverter; and
processing circuitry configured to cause the electric drive to adjust at least one of a resonant capacitance or a resonant inductance of the inverter to cause the inverter to operate in a soft switching mode, in response to the inverter being in a hard switching mode.

2. The electric drive of claim 1, wherein the processing circuitry is further configured to cause the electric drive to:
determine a phase output current of an electric motor; and
detect the hard switching mode of the inverter based on the phase output current.

3. The electric drive of claim 2, wherein the processing circuitry is further configured to cause the electric drive to:
determine a resonant inductor current of the inverter; and
detect the hard switching mode based on the resonant inductor current and the phase output current.

4. The electric drive of claim 3, wherein the processing circuitry is further configured to cause the electric drive to:
estimate a total charge of a resonance circuit of the inverter based on the resonant inductor current and the phase output current; and
detect the hard switching mode based on the estimated total charge.

5. The electric drive of claim 3, wherein the processing circuitry is further configured to cause the electric drive to:
estimate a total charge of a resonance circuit of the inverter by determining a difference between the resonant inductor current and the phase output current, and
integrating the difference; and
detect the hard switching mode based on based on the estimated total charge.

6. The electric drive of claim 3, wherein the processing circuitry is further configured to cause the electric drive to:
adjust the at least one of the resonant capacitance or the resonant inductance of the inverter such that a total charge of a resonance circuit of the inverter is greater than a value of a voltage of a DC power source of the inverter multiplied by the resonant capacitance of the inverter.

7. The electric drive of claim 3, wherein the processing circuitry is further configured to cause the electric drive to:
adjust the at least one of the resonant capacitance or the resonant inductance of the inverter such that a total charge of a resonance circuit of the inverter is greater than twice a value of a voltage of a DC power source of the inverter multiplied by the resonant capacitance of the inverter.

8. The electric drive of claim 1, wherein the processing circuitry is further configured to cause the electric drive to:
adjust the at least one of the resonant capacitance or the resonant inductance of the inverter in response to a total charge of a resonance circuit of the inverter being below a threshold value.

9. The electric drive of claim 1, wherein the processing circuitry is further configured to cause the electric drive to:
detect the hard switching mode of the inverter based on a device temperature of the inverter.

10. The electric drive of claim 2, wherein the processing circuitry is further configured to cause the electric drive to:
adjust the at least one of the resonant capacitance or the resonant inductance of the inverter based on an estimated machine parasitic capacitance of the electric motor.

11. The electric drive of claim 10, wherein the processing circuitry is further configured to cause the electric drive to:
generate the estimated machine parasitic capacitance by filtering the phase output current using a high pass filter and performing a fast Fourier transform (FFT) analysis on the filtered phase output current.

12. The electric drive of claim 10, wherein the processing circuitry is further configured to cause the electric drive to:
adjust at least one of the resonant capacitance or the resonant inductance of the inverter based on the estimated machine parasitic capacitance and a lookup table.

13. The electric drive of claim 1, wherein the processing circuitry is further configured to cause the electric drive to:
detect the hard switching mode during a pre-power on diagnosis of the electric drive.

14. The electric drive of claim 1, wherein the processing circuitry is further configured to cause the electric drive to:
determine a voltage fall time of the inverter; and
detect the hard switching mode based on the voltage fall time.

15. The electric drive of claim 14, wherein the processing circuitry is further configured to cause the electric drive to:
determine the hard switching mode in response to the voltage fall time being below a threshold time.

16. The electric drive of claim 14, wherein the processing circuitry is further configured to cause the electric drive to:
determine the voltage fall time by
determining a first crossing time when a device voltage of the inverter is equal to a first comparison voltage,
determining a second crossing time when the device voltage of the inverter is equal to a second comparison voltage, and
determining the voltage fall time based on the first crossing time and the second crossing time.

17. The electric drive of claim 14, wherein the voltage fall time corresponds with a time point when a device voltage of the inverter is within a threshold voltage above or below zero volts.

18. The electric drive of claim 1, wherein the processing circuitry is further configured to cause the electric drive to:
detect the hard switching mode based on a gate signal of the inverter.

19. The electric drive of claim 18, wherein the processing circuitry is further configured to cause the electric drive to:
detect a Miller plateau phenomenon based on the gate signal; and
determine the hard switching mode in response to detecting the Miller plateau phenomenon.

20. The electric drive of claim 19, wherein the processing circuitry is further configured to cause the electric drive to:
determine a difference between an actual voltage of the gate signal and an ideal voltage of the gate signal; and
detect the Miller plateau phenomenon based on the difference.
